(19) United States
(12) Patent Application Publication
(10) Pub. No.: US 2026/0200480 A1
(43) Pub. Date: Jul. 16, 2026

(54) VEHICLE COMPATIBLE WITH AUTOMATED VALET PARKING

(71) Applicant: TOYOTA JIDOSHA KABUSHIKI KAISHA, Toyota-shi (JP)

(72) Inventors: Tatsuya SUGANO, Seto-shi (JP); Hidenobu KINUGASA, Nagoya-shi (JP); Takahiro YAMAMOTO, Toyota-shi (JP)

(73) Assignee: TOYOTA JIDOSHA KABUSHIKI KAISHA, Toyota-shi (JP)

(21) Appl. No.: 19/377,059

(22) Filed: Nov. 3, 2025

(30) Foreign Application Priority Data
Jan. 9, 2025 (JP) 2025-003557

(51) Int. Cl. B60W 50/00; B60W 30/06

(52) U.S. Cl. CPC B60W 50/0098; B60W 30/06; B60W 2555/20

(57) ABSTRACT

The vehicle control device acquires weather conditions at the time of use of the automated valet parking, determines the effectiveness of the infrastructure sensor installed in the parking lot based on the weather conditions, and also determines the effectiveness of the in-vehicle sensor based on the weather conditions. The vehicle control device performs automated valet parking based on sensing information of a valid sensor of at least one of the infrastructure sensor and the in-vehicle sensor.

### CROSS-REFERENCE TO RELATED APPLICATION

This application claims priority to Japanese Patent Application No. 2025-003557 filed on Jan. 9, 2025. The disclosure of the above-identified application, including the specification, drawings, and claims, is incorporated by reference herein in its entirety.

### BACKGROUND

### 1. Technical Field

The present disclosure relates to a vehicle compatible with automated valet parking.

### 2. Description of Related Art

Japanese Unexamined Patent Application Publication No. 2021-84626 (JP 2021-84626 A) discloses a technique in which an infrastructure that supports automated valet parking receives a parking request from a vehicle. Then, it is checked whether a sensor mounted on the vehicle operates normally, and whether required operation required for the automated valet parking is performed by the vehicle. It is determined whether the automated valet parking can be performed for the vehicle based on the check results.

### SUMMARY

Each in-vehicle sensor may not operate well in some weather conditions, depending on the characteristics of the in-vehicle sensor. Therefore, there is a possibility of hindering automated valet parking based on information sensed by an in-vehicle sensor under weather conditions in which the in-vehicle sensor does not operate well. Similar problems may occur in systems in which automated valet parking is performed using sensors provided in the infrastructure. This is because the weather conditions also affect the sensors provided in the infrastructure.

An aspect of the present disclosure provides
a vehicle compatible with automated valet parking, including: an in-vehicle sensor that performs sensing around the vehicle; and
a vehicle control device connected to the in-vehicle sensor.

The vehicle control device acquires a weather condition at a time of use of the automated valet parking;
determines effectiveness of an infrastructure sensor installed in a parking lot based on the weather condition; and determines effectiveness of the in-vehicle sensor based on the weather condition; and
Then, the vehicle control device executes the automated valet parking based on information sensed by an effective sensor that is at least one of the infrastructure sensor and the in-vehicle sensor.

According to the present disclosure, the effectiveness of each of the infrastructure sensor and the in-vehicle sensor is determined for each section of the travel route based on the weather condition, and automated valet parking is executed based on information sensed by an effective sensor that is at least one of such sensors. Accordingly, it is possible to improve the safety of the automated valet parking by suppressing the effect of the weather condition.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating a configuration of an automated valet parking system;

FIG. 2 is a diagram illustrating a specific example of selection of a sensor according to weather conditions;

FIG. 3 is a diagram illustrating a specific example of selection of a sensor according to weather conditions;

FIG. 4 is a flowchart illustrating an exemplary process executed by the vehicle control device at the beginning of the automated valet parking; and

FIG. 5 is a flowchart illustrating an example of a process executed in the infrastructure when the effectiveness of a sensor is determined in the infrastructure at the start of automated valet parking.

### DETAILED DESCRIPTION OF EMBODIMENTS

### 1. Configuring an Automated Valet Parking System

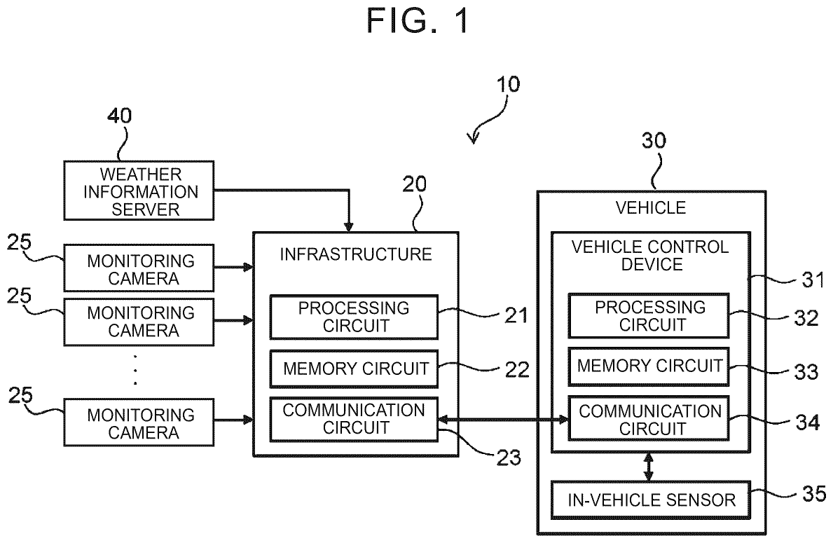

FIG. 1 shows a configuration of an automated valet parking system 10 according to the present embodiment. The automated valet parking system 10 includes an infrastructure 20 that supports automated valet parking, and a vehicle 30 that supports automated valet parking.

Infrastructure 20 is a computer that controls vehicle 30 in a parking lot where automated valet parking system 10 is provided. The infrastructure 20 may be a physical server, a cloud server, or a combination of a physical server and a cloud server. The infrastructure 20 acquires sensing information for automated valet parking from a plurality of infrastructure sensors installed in a parking lot in real time, and performs processing related to automated valet parking based on the sensing information.

A representative example of the infrastructure sensor is a monitoring camera 25 arranged along a road on which the vehicle 30 travels. During automated driving by automated valet parking, the vehicle 30 enters an imaging range of at least one monitoring camera 25. The monitoring camera 25 is disposed at a height such as a ceiling, a wall, a support, and the like, and photographs the vehicle 30 from above. The photographing angle of the monitoring camera 25 may be adjusted so as to photograph the vehicle 30 from directly above, or may be adjusted so as to photograph the vehicle 30 from obliquely forward, obliquely rearward, or obliquely sideways. In addition to the monitoring cameras 25, LiDAR or millimeter-wave radars may be provided as infrastructure sensors.

The infrastructure 20 includes a processing circuit 21, a storage circuit 22, and a communication circuit 23. The processing circuit 21 is a circuit configured to perform processing related to automated valet parking. The sensing information of the infrastructure sensor including the camera image of the monitoring camera 25 is processed by the processing circuit 21. Processing circuit 21 includes one or more processors, such as CPU, FPGA, or ASIC. The storage circuit 22 is a circuit configured to store a program related to automated valet parking and related data thereof. The storage circuit 22 includes one or more primary memories, and may further include one or more secondary storage. The communication circuit 23 is a circuit configured to communicate with the outside. The communication circuit 23 includes a wireless communication module for performing wireless communication and a wired communication module for performing wired communication. The processing circuit 21 is communicably connected to the storage circuit 22 and the communication circuit 23.

The communication circuit 23 is connected to the weather information server 40 provided by the weather information providing company. The infrastructure 20 acquires weather conditions when using automated valet parking from the weather information server 40.

The vehicle 30 has a function necessary for automated valet parking including an automated driving function, and is a target vehicle to be subjected to automated valet parking. Automated driving of the vehicle 30 in the parking lot is controlled by cooperation between the infrastructure 20 and the vehicle control device 31 mounted on the vehicle 30. The vehicle 30 may be an autonomous driving vehicle that can autonomously travel outside the parking lot.

The vehicle 30 includes an in-vehicle sensor 35 that senses the surroundings of the vehicle 30. The in-vehicle sensor 35 includes at least one of a camera, a LiDAR, and a millimeter-wave radar. The in-vehicle sensor 35 is communicably connected to the vehicle control device 31. The sensing information obtained by the in-vehicle sensor 35 is processed by the vehicle control device 31.

The vehicle control device 31 includes a processing circuit 32, a storage circuit 33, and a communication circuit 34. The processing circuit 32 is a circuit configured to perform processing related to automated valet parking. Processing circuit 32 may include one or more processors, such as a CPU, FPGA, or ASIC. The storage circuit 33 is a circuit configured to store a program related to automated valet parking and related data thereof. The storage circuit 33 includes one or more primary memories, and may further include one or more secondary storage. The communication circuit 34 is a circuit configured to communicate with the communication circuit 23 of the infrastructure 20. The communication circuit 34 includes a wireless LAN module for performing wireless communication over a wireless LAN. The processing circuit 32 is communicably connected to the storage circuit 33 and the communication circuit 34.

### 2. Function of the Vehicle Control Device

The vehicle control device 31 controls the operation of the vehicle 30 in accordance with a control instruction from the infrastructure 20. The control instruction is an instruction related to operation control of the vehicle 30 for automated valet parking. The motion control includes starting the vehicle 30, accelerating the vehicle 30, decelerating the vehicle 30, stopping the vehicle 30, and steering the vehicle 30. The infrastructure 20 generates a control instruction so that the vehicle 30 can autonomously travel along the travel route based on the sensing information of the infrastructure sensor including the camera image of the monitoring camera 25. Typically, the infrastructure 20 generates, as a control instruction, a waypoint in which data such as target position information, curve information, speed information, and gradient information is defined.

In addition to the operation control based on the control instruction from the infrastructure 20, the vehicle control device 31 can also create a travel plan based on the sensing information of the in-vehicle sensor 35 and perform the operation control of the vehicle 30 in accordance with the travel plan. The operation control based on the sensing information of the in-vehicle sensor 35 includes stop control for avoiding collision with an obstacle detected by the in-vehicle sensor 35 or reducing collision damage. The stop control is typically an emergency brake.

The vehicle control device 31 can execute either one of the operation control based on the control instruction from the infrastructure 20 and the operation control based on the sensing information of the in-vehicle sensor 35, or a combination of both. However, the execution of the operation control based on the control instruction from the infrastructure 20 is limited to the case where the infrastructure sensor including the monitoring camera 25 is valid. Execution of the operation control based on the sensing information of the in-vehicle sensor 35 is limited to the case where the in-vehicle sensor 35 is valid.

The vehicle control device 31 determines the effectiveness of the infrastructure sensor including the monitoring camera 25 and the effectiveness of the in-vehicle sensor 35 based on weather conditions at the time of use of automated valet parking. Each of the infrastructure sensor and the in-vehicle sensor 35 has a weather condition that is not favorable, and effective sensing information is not always obtained under a weather condition that is not favorable. For example, the monitoring camera 25 may have low effectiveness in backlight, snowfall, and rainfall. The camera of the in-vehicle sensor 35 may also have low effectiveness in backlight, snowfall, and rainfall. LiDAR of the in-vehicle sensor 35 may be less effective when mist is emitted, when it rains, and when it snows. The vehicle control device 31 acquires, from the infrastructure 20, weather conditions that serve as a material for determining the effectiveness of each sensor. However, the vehicle control device 31 can also directly acquire weather conditions from the weather information server 40 of the weather information providing company.

### 3. Specific Examples of Sensor Selection According to Weather Conditions

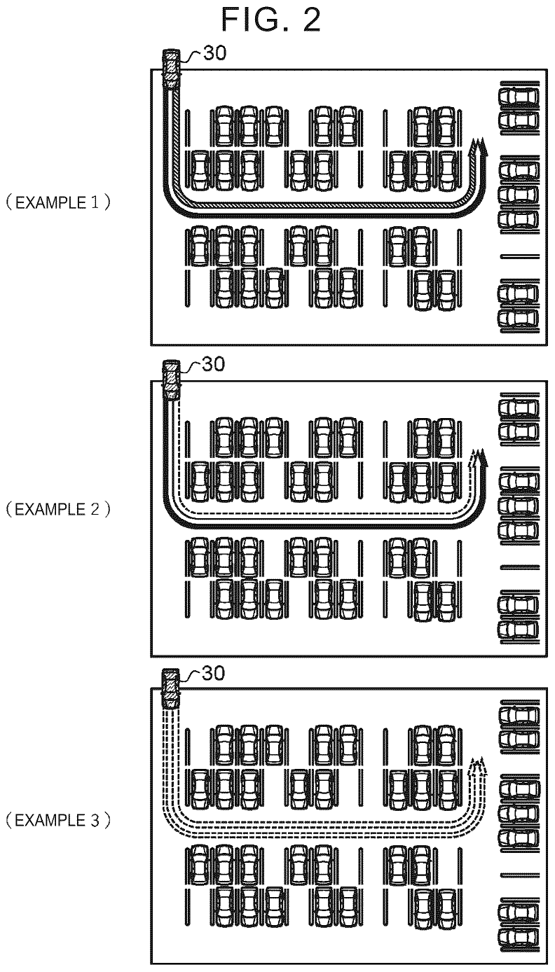

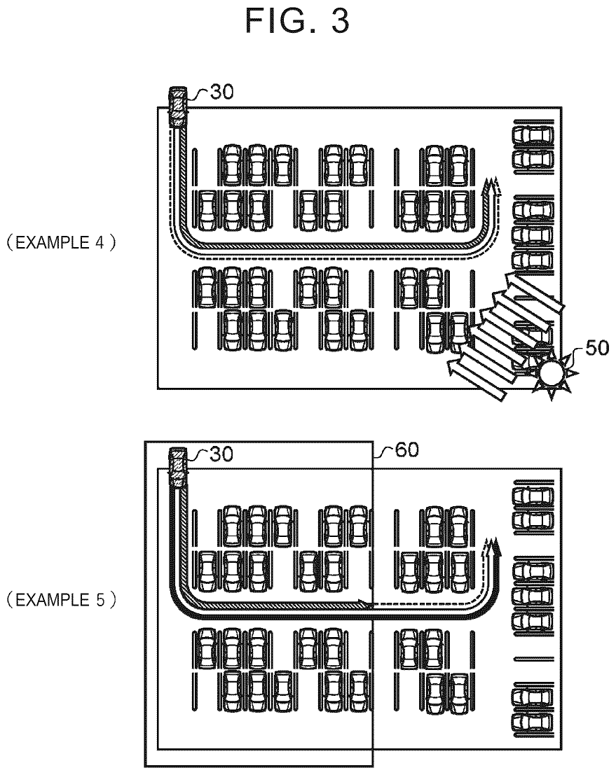

FIG. 2 and FIG. 3 show specific examples of selection according to weather conditions of a sensor for acquiring sensing information for automated valet parking. In the embodiments, the infrastructure sensor is a monitoring camera, and the in-vehicle sensor is an in-vehicle camera and an in-vehicle LiDAR. In each specific example, a section of a white arrow line indicates an effective section of the monitoring camera, and a section of a black arrow line indicates an effective section of the vehicle-mounted camera. The hatched section of the arrow line indicates the valid section of the in-vehicle LiDAR, and the section of the dotted arrow line indicates the invalid section of the respective sensors.

Example 1 is a case where the weather conditions are good for the sensor. In this case, it is determined that all of the monitoring camera, the in-vehicle camera, and the in-vehicle LiDAR are valid. The vehicle control device 31 can perform any one of operation control based on the sensing information of the monitoring camera, operation control based on the sensing information of the in-vehicle camera and the in-vehicle LiDAR, and operation control based on all of the sensing information.

The second embodiment is a case in which a mist is generated in the parking lot. The fog may reduce the effectiveness of LiDAR. Therefore, in this case, it is determined that the monitoring camera and the in-vehicle camera are valid, but it is determined that the in-vehicle LiDAR is not useful. The vehicle control device 31 can perform any one of operation control based on the sensing information of the monitoring camera, operation control based on the sensing information of the in-vehicle camera, and operation control based on all of the sensing information.

Example 3 is a case in which snow is heavily falling in the parking lot. Snow may reduce the effectiveness of the cameras and may also reduce the effectiveness of LiDAR. Therefore, in this case, it is determined that all of the monitoring camera, the in-vehicle camera, and the in-vehicle LiDAR are not useful. Since the vehicle control device 31 cannot execute the operation control based on the sensing information of any sensor, the start of the automated valet parking is suspended.

In the specific example 4, the light from the sun 50 is backlit with respect to the traveling direction of the vehicle 30. Backlight may reduce the effectiveness of the camera. Since a plurality of monitoring cameras is provided in the parking lot in various directions, even if a certain monitoring camera is backlit, another monitoring camera is not backlit. On the other hand, the in-vehicle camera is always backlit. In this case, the monitoring camera and the in-vehicle LiDAR are determined to be valid, but the in-vehicle camera is determined to be useless. The vehicle control device 31 can perform any one of operation control based on the sensing information of the monitoring camera, operation control based on the sensing information of the in-vehicle LiDAR, and operation control based on all of the sensing information.

In Example 5, a part of the parking lot is a case in which fog is emitted outside the building 60 in the building 60. The vehicle control device 31 divides the traveling route into a plurality of sections, and determines the effectiveness of each sensor for each section of the traveling route. In this case, it is determined that all of the monitoring camera, the in-vehicle camera, and the in-vehicle LiDAR are valid in the section in the building 60. The vehicle control device 31 can perform any one of operation control based on sensing information of the monitoring camera, operation control based on sensing information of the vehicle-mounted camera and the vehicle-mounted LiDAR, or operation control based on all of the sensing information in the section in the building 60. On the other hand, in a section outside the building 60, the monitoring camera and the in-vehicle camera are determined to be valid, but the in-vehicle LiDAR is determined to be useless. In a section outside the building 60, the vehicle control device 31 can execute either operation control based on sensing information of the monitoring camera, operation control based on sensing information of the in-vehicle camera, or operation control based on all of the sensing information.

### 4. Processing Performed by the Automated Valet Parking System

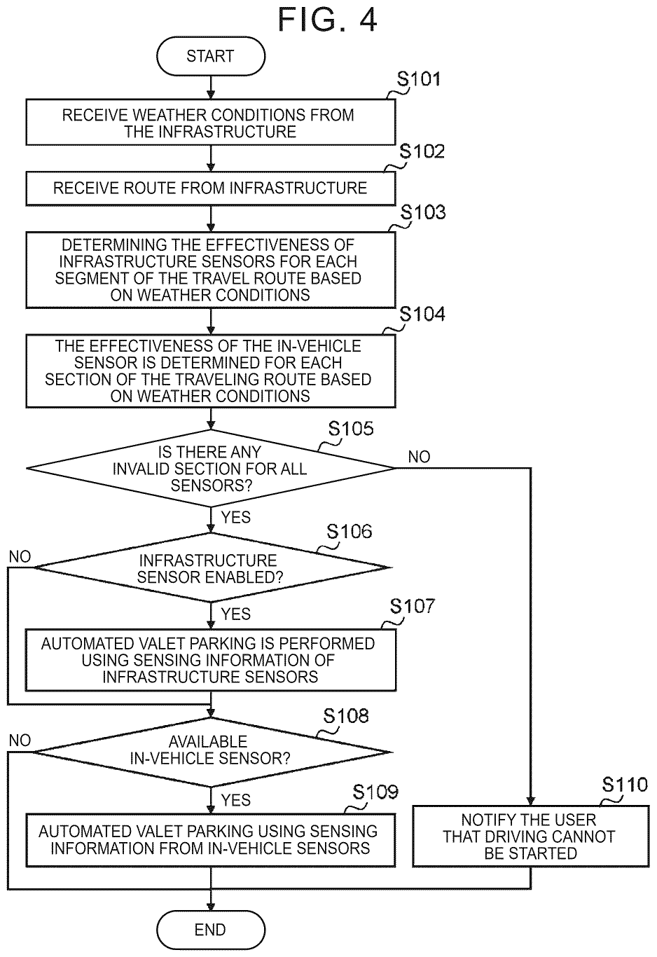

FIG. 4 is a flowchart illustrating an example of a process executed by the vehicle control device 31 at the start of automated valet parking. Specifically, the processing illustrated in this flowchart is executed by the processing circuit 32 of the vehicle control device 31.

In S101, the vehicle control device 31 receives the weather conditions of the parking lot from the infrastructure 20. Further, in S102, the vehicle control device 31 receives the travel route of the vehicle 30 from the infrastructure 20. Then, in S103, the vehicle control device 31 determines the effectiveness of the infrastructure sensor including the monitoring camera 25 for each section of the traveling route based on the weather condition. In addition, in S104, the vehicle control device 31 determines the effectiveness of the in-vehicle sensor 35 for each section of the traveling route based on the weather condition.

In S105, the vehicle control device 31 determines whether or not there is no invalid section of all sensors on the traveling route based on S103 and S104 determination. When such a section exists even in a part, the vehicle 30 cannot move to the destination by automated driving. That is, in such a case, automated valet parking cannot be achieved. When there is an invalid section of all the sensors on the traveling route, the vehicle control device 31 notifies the user that the traveling of the vehicle 30 cannot be started in S110. On the other hand, when there is no invalid section of all sensors on the traveling route, the process by the vehicle control device 31 proceeds to S106.

In S106, the vehicle control device 31 determines whether the infrastructure sensor including the monitoring camera 25 is valid. When the infrastructure sensor is enabled, the process by the vehicle control device 31 proceeds to S107. In S107, the vehicle control device 31 performs automated valet parking using the sensing information of the infrastructure sensor. After S107 is executed, the process by the vehicle control device 31 proceeds to S108. When S106 is not satisfied, the process by the vehicle control device 31 skips S107 and proceeds to S108.

In S108, the vehicle control device 31 determines whether the in-vehicle sensor 35 is valid. When the in-vehicle sensor 35 is valid, the process by the vehicle control device 31 proceeds to S109. In S109, the vehicle control device 31 performs automated valet parking using the sensing data of the in-vehicle sensor 35. When both S106 and S108 are satisfied, the vehicle control device 31 performs automated valet parking using both the sensing information of the in-vehicle sensor 35 and the sensing information of the infrastructure sensor. The reason is to improve the safety of automated valet parking. In this case, the sensing information of the in-vehicle sensor 35 may be corrected by the sensing information of the infrastructure sensor, or the sensing information of the infrastructure sensor may be corrected by the sensing information of the in-vehicle sensor 35. After S109 is executed, the process by the vehicle control device 31 ends. When S108 is not satisfied, the process by the vehicle control device 31 skips S109 and ends.

By executing the above processing by the vehicle control device 31, the effectiveness of each of the infrastructure sensor including the monitoring camera 25 and the in-vehicle sensor 35 is determined for each section of the traveling route based on the weather conditions. In this way, automated valet parking is performed based on sensing information of at least one valid sensor. Accordingly, it is possible to suppress the influence of weather conditions and improve the safety of automated valet parking.

Note that the vehicle control device 31 may change the operating condition of the stopping control based on the sensing information of the in-vehicle sensor 35 in accordance with the effectiveness of the in-vehicle sensor 35 determined by S108. For example, when the in-vehicle sensor 35 is enabled, the stop control based on the sensing information of the in-vehicle sensor 35 may be activated, and when the in-vehicle sensor 35 is disabled, the stop control based on the sensing information of the in-vehicle sensor 35 may not be activated. Accordingly, it is possible to prevent the stop control from being unnecessarily operated due to a malfunction of the in-vehicle sensor 35.

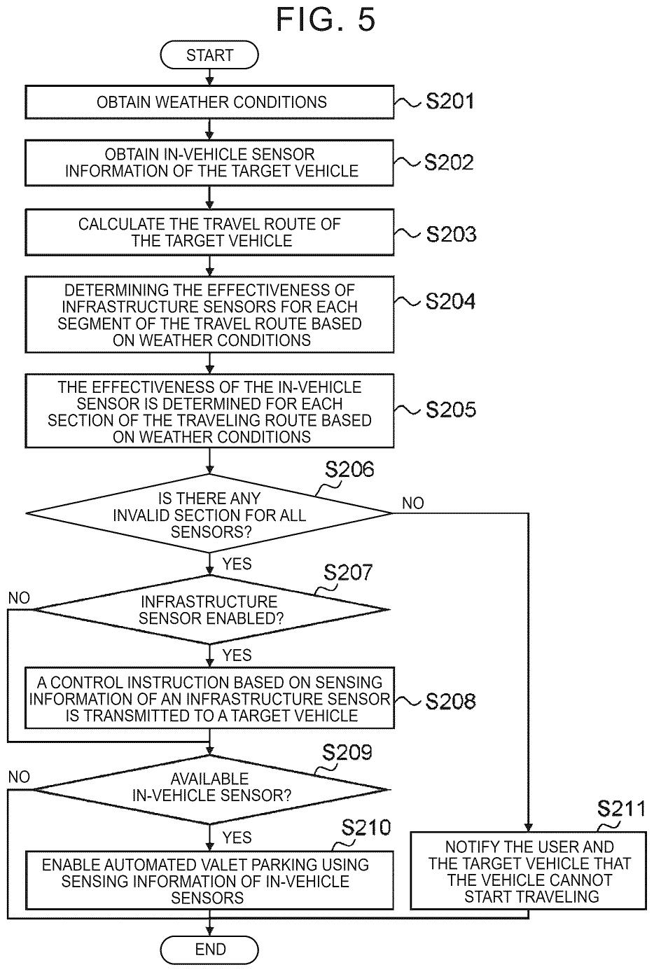

Determination of the effectiveness of the sensor can also be made in the infrastructure 20. FIG. 5 is a flowchart illustrating an example of a process executed in the infrastructure 20 when the effectiveness of a sensor is determined in the infrastructure 20 at the start of automated valet parking. Specifically, the processing illustrated in this flowchart is executed by the processing circuit 21 of the infrastructure 20.

In S201, the infrastructure 20 receives the weather conditions of the parking lot from the weather information servers 40. In addition, in S202, the infrastructure 20 acquires the in-vehicle sensor data related to the type and specifications of the in-vehicle sensor 35 of the vehicle 30 that is the target of the automated valet parking. Further, in S203, the infrastructure 20 calculates the travel route of the vehicles 30 when performing automated valet parking. Then, in S204, the infrastructure 20 determines the effectiveness of the infrastructure sensor including the monitoring camera 25 based on the weather conditions for each section of the traveling route. In addition, in S205, the infrastructure 20 determines the effectiveness of the in-vehicle sensor 35 for each section of the traveling route based on the weather conditions.

In S206, the infrastructure 20 determines whether there is no invalid section of all sensors on the travel route based on S204 and S205 determinations. If there is an invalid section of all sensors on the travel route, the infrastructure 20 notifies the user and the vehicle 30 that the vehicle 30 cannot begin traveling in S211. On the other hand, if there is no invalid section of all sensors on the driving route, the process by the infrastructure 20 proceeds to S207.

In S207, the infrastructure 20 determines whether an infrastructure sensor including the monitoring camera 25 is valid. If the infrastructure sensor is enabled, the process by infrastructure 20 proceeds to S208. In S208, the infrastructure 20 transmits a control instruction generated based on the sensing data of the infrastructure sensor to the vehicles 30. After S208 is executed, the process by the infrastructure 20 proceeds to S209. When S207 is not satisfied, the infrastructure 20 skips S208 and proceeds to S209.

In S209, the infrastructure 20 determines whether the in-vehicle sensor 35 is valid. If the in-vehicle sensor 35 is enabled, the process by the infrastructure 20 proceeds to S210. In S210, the infrastructure 20 permits the vehicles 30 to automated valet parking using the sensing data of the in-vehicle sensors 35. After S210 is executed, the process by the infrastructure 20 ends. When S209 is not satisfied, the process by the infrastructure 20 skips S210 and ends.

### 5. Other

It should be noted that the above-described embodiments include the following technical ideas related to an automated valet parking system and an automated valet parking method.

### Technical Idea 1

A system for providing automated valet parking to a target vehicle, comprising:
A processing circuit is provided,
The processing circuit,
Obtain weather conditions when using the automated valet parking by the target vehicle,
Based on the weather conditions described above, the effectiveness of the infrastructure sensor installed in the parking lot is determined.
Based on the weather conditions, the effectiveness of the in-vehicle sensor of the target vehicle is determined.
It is configured to perform the automated valet parking for the target vehicle based on sensing information of an effective sensor of at least one of the infrastructure sensor and the in-vehicle sensor
Automated Valet Parking System, characterized in that.

### Technical Idea 2

A method wherein a computer provides automated valet parking to a target

vehicle, the method comprising:
Acquiring weather conditions during use of the automated valet parking by the target vehicle;
Determining the effectiveness of the infrastructure sensor installed in the parking lot based on the weather conditions;
Determining the effectiveness of the in-vehicle sensor of the target vehicle based on the weather condition,
The method includes performing the automated valet parking for the target vehicle based on sensing information of a valid sensor of at least one of the infrastructure sensor and the in-vehicle sensor
An automated valet parking method, characterized in that.

What is claimed is:

1. A vehicle compatible with automated valet parking, comprising:
an in-vehicle sensor that performs sensing around the vehicle; and
a vehicle control device connected to the in-vehicle sensor, wherein
the vehicle control device is configured to:
acquire a weather condition at a time of use of the automated valet parking;
determine effectiveness of an infrastructure sensor installed in a parking lot based on the weather condition;
determine effectiveness of the in-vehicle sensor based on the weather condition; and
execute the automated valet parking based on information sensed by an effective sensor that is at least one of the infrastructure sensor and the in-vehicle sensor.

2. The vehicle according to claim 1, wherein the vehicle control device is configured to determine the effectiveness of the infrastructure sensor and determine the effectiveness of the in-vehicle sensor for each section of a travel route.

3. The vehicle according to claim 1, wherein the vehicle control device is configured to, when the infrastructure sensor is effective, acquire an instruction related to operation control for the vehicle prepared based on information sensed by the infrastructure sensor from an infrastructure, and cause the vehicle to operate according to the instruction related to the operation control.

4. The vehicle according to claim 1, wherein the vehicle control device is configured to, when the in-vehicle sensor is effective, prepare a travel plan based on information sensed by the in-vehicle sensor, and cause the vehicle to operate according to the travel plan.

5. The vehicle according to claim 1, wherein the vehicle control device is configured not to start the automated valet parking when neither of the infrastructure sensor and the in-vehicle sensor is effective.

6. The vehicle according to claim 1, wherein the vehicle control device is configured to change an activation condition for stop control based on information sensed by the in-vehicle sensor according to effectiveness of the in-vehicle sensor.
